(19) United States
(12) Patent Application Publication
(10) Pub. No.: US 2024/0281353 A1
(43) Pub. Date: Aug. 22, 2024

(54) DETERMINATION DEVICE, DETERMINATION METHOD, AND DETERMINATION PROGRAM

(71) Applicant: NIPPON TELEGRAPH AND TELEPHONE CORPORATION, Tokyo (JP)

(72) Inventors: Fumihiro YOKOSE, Tokyo (JP); Kimio TSUCHIKAWA, Tokyo (JP); Sayaka YAGI, Tokyo (JP); Yuki URABE, Tokyo (JP); Taisuke WAKASUGI, Tokyo (JP); Haruo OISHI, Tokyo (JP)

(73) Assignee: NIPPON TELEGRAPH AND TELEPHONE CORPORATION, Tokyo (JP)

(21) Appl. No.: 18/568,383

(22) PCT Filed: Jun. 11, 2021
(86) PCT No.: PCT/JP2021/022416

§ 371 Date: Dec. 8, 2023

(51) Int. Cl. G06F 11/30; G06F 11/34

(52) U.S. Cl. CPC G06F 11/3072; G06F 11/3476

(57) ABSTRACT

A determination device (10) includes: a reception unit (15a) that receives an operation event; an estimation unit (15b) that estimates a determination criterion for determining whether the operation event is necessary or unnecessary on the basis of an attribute value of an operation log included in the operation event; and a determination unit (15c) that determines whether an operation event to be processed is necessary or unnecessary on the basis of the determination criterion.

### TECHNICAL FIELD

The present invention relates to a determination device, a determination method, and a determination program.

### BACKGROUND ART

Conventionally, there has been known a process mining method of analyzing and visualizing a flow of work performed in business to find an improvement point in the business. Information used for analysis and visualization in such a process mining method is a log in which an event to be analyzed is recorded. For example, there are various events to be analyzed depending on a type of business and granularity to be analyzed, but for example, a graphical user interface (GUI) operation may be targeted, such as “clicking a button” or “inputting to a text box”.

The log used for process mining needs to satisfy, for example, requirements that the log is “narrowed down to only information to be analyzed”, “divided for each case”, and “in a state where an event can be identified”. For example, an operation log in which an operation on a personal computer (PC) is recorded often does not satisfy the requirements of the log used for the process mining. For that reason, when the process mining is performed, for example, the operation log needs to be processed to satisfy the requirements by three pieces of pre-processing, “removal of an unnecessary operation event”, “determination of identical operation events”, and “division in units of cases”.

Here, processing of “removal of an unnecessary operation event” is processing of removing unnecessary information included in the operation log. That is, the operation log may include an unnecessary operation event as information not related to work to be analyzed. Conventionally, in analysis and visualization of an operation on a PC for finding an improvement point in business, a person manually performs processing of removing the unnecessary operation event, for example, by visually confirming an operation log and deletes unnecessary events one by one.

### CITATION LIST

### Non Patent Literature

Non Patent Literature 1: Yokose, Urabe, Yagi, et al., “Business visualization technology contributing to DX promotion”, 2020, NTT Technical Journal, 2020 vol. 32 No. 2, p. 72-75, [online], [Searched on Apr. 23, 2021], Internet <https://journal.ntt.co.jp/article/880>

### SUMMARY OF INVENTION

### Technical Problem

However, in the above-described conventional technique, the unnecessary operation event cannot be easily removed in the pre-processing for the process mining. This is because the above-described conventional technique has the following problems.

First, it is possible to manually remove unnecessary events one by one, but in a case where there are a large amount of logs, it is difficult to manually remove all of them.

On the other hand, since systems to be analyzed in the process mining have different internal structures, a target to be removed cannot be automatically determined by a fixed rule algorithm. In addition, it is also possible to cope with this by manually customizing the rule algorithm in accordance with the internal structures and work of the systems, but it is necessary to understand the internal structures of the systems and meanings of attribute values included in the operation log, so that it is difficult for a general user.

### Solution to Problem

To solve the above-described problems and achieve an object, a determination device according to the present invention includes: a reception unit that receives a log event; an estimation unit that estimates a determination criterion for determining whether the log event is necessary or unnecessary on the basis of an attribute value of a log included in the log event; and a determination unit that determines whether a log event to be processed is necessary or unnecessary on the basis of the determination criterion.

In addition, a determination method according to the present invention is a determination method executed by a determination device, the determination method including: a process of receiving a log event; a process of estimating a determination criterion for determining whether the log event is necessary or unnecessary on the basis of an attribute value of a log included in the log event; and a process of determining whether a log event to be processed is necessary or unnecessary on the basis of the determination criterion.

In addition, a determination program according to the present invention causes a computer to execute: a step of receiving a log event; a step of estimating a determination criterion for determining whether the log event is necessary or unnecessary on the basis of an attribute value of a log included in the log event; and a step of determining whether a log event to be processed is necessary or unnecessary on the basis of the determination criterion.

### Advantageous Effects of Invention

In the present invention, the unnecessary operation event can be easily removed in the pre-processing for the process mining.

### BRIEF DESCRIPTION OF DRAWINGS

FIG. 1 is a block diagram illustrating a configuration example of a determination device according to a first embodiment.

FIG. 2 is a diagram illustrating a log stored in a storage unit according to the first embodiment.

FIG. 3 is a diagram illustrating an example of processing of receiving exemplification by selection of an operation event according to the first embodiment.

FIG. 4 is a diagram illustrating an example of a rule type for each of attribute elements according to the first embodiment.

FIG. 5 is a diagram illustrating an example of determination criterion estimation processing according to the first embodiment.

FIG. 6 is a diagram illustrating an example of operation event determination processing according to the first embodiment.

FIG. 7 is a flowchart illustrating an example of a flow of entire processing according to the first embodiment.

FIG. 8 is a diagram for explaining process mining.

FIG. 9 is a diagram for explaining pre-processing for process mining.

FIG. 10 is a diagram for explaining a conventional problem.

FIG. 11 is a diagram illustrating a computer that executes a program.

### DESCRIPTION OF EMBODIMENTS

Hereinafter, embodiments of a determination device, a determination method, and a determination program according to the present invention will be described in detail with reference to the drawings. In addition, the present invention is not limited to the embodiments described below.

### First Embodiment

Hereinafter, processing performed by a determination system, a configuration of a determination device 10, details of each of pieces of processing, and a flow of each of pieces of processing according to a first embodiment (as appropriate, a present embodiment) will be sequentially described, and finally, effects of the present embodiment will be described.

### [Processing Performed by Determination System]

Hereinafter, processing performed by the determination system (as appropriate, the present system) according to the present embodiment will be described. The present system is used for processing an operation log in which an operation on a PC is recorded, and particularly executes automatic determination processing for an unnecessary operation event by the user's exemplification. Hereinafter, the processing performed by the present system will be described in comparison with a conventional technique.

The process mining method for business analysis described above is widely used in the market. In addition, there is also a mechanism for recording the operation on the PC as a log (operation log). At this time, pre-processing may be required to perform process mining on the operation log. That is, if the operation log is recorded as it is, an event other than a process mining target is also included, and thus, it is necessary to remove an unnecessary event. In addition, it is possible to manually remove unnecessary events one by one, but in a case where there are a large amount of logs, it is difficult to manually remove all of them.

On the other hand, since systems to be analyzed in the process mining have different internal structures, a target to be removed cannot be automatically determined by a fixed rule algorithm. In addition, it is also possible to cope with this by manually customizing the rule algorithm in accordance with the internal structures and work of the systems, but it is necessary to understand the internal structures of the systems and meanings of attribute values included in the operation log.

Thus, in the present system, the following processing is executed. First, the user is caused to exemplify a plurality of operation events to be left/removed. Second, a rule for determining an operation event to be left/removed is estimated from a relationship of attribute values between the exemplified operation events. Third, an operation event to be left/removed is automatically determined by using the estimated rule. According to the above processing, it is possible to automatically perform removal of an unnecessary operation by the user's exemplification even if there is no deep understanding of an internal structure of a system to be analyzed and the attribute value of the operation log.

### [Configuration of Determination Device 10]

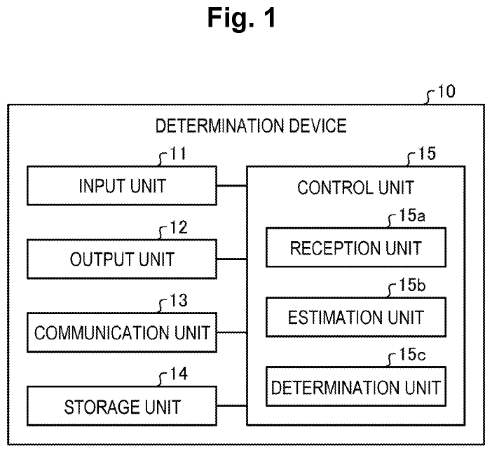

A configuration of the determination device 10 according to the present embodiment will be described in detail with reference to FIG. 1. FIG. 1 is a block diagram illustrating a configuration example of the determination device according to the present embodiment. The determination device 10 includes an input unit 11, an output unit 12, a communication unit 13, a storage unit 14, and a control unit 15.

The input unit 11 manages input of various types of information to the determination device 10. For example, the input unit 11 is implemented by a mouse, a keyboard, or the like, and receives an input of setting information or the like to the determination device 10. In addition, the output unit 12 manages output of various types of information from the determination device 10. For example, the output unit 12 is implemented by a display or the like, and outputs setting information or the like stored in the determination device 10.

The communication unit 13 manages data communication with other devices. For example, the communication unit 13 performs data communication with each of communication devices. In addition, the communication unit 13 can perform data communication with an operator's terminal (not illustrated).

The storage unit 14 stores various types of information referred to when the control unit 15 operates, and stores various types of information acquired when the control unit 15 operates. Here, the storage unit 14 can be implemented by, for example, a semiconductor memory device such as a random access memory (RAM) or a flash memory, a storage device such as a hard disk or an optical disk, or the like. Note that, in the example of FIG. 1, the storage unit 14 is installed inside the determination device 10, but may be installed outside the determination device 10, or a plurality of storage units may be installed.

The storage unit 14 stores an operation log to be processed. For example, the storage unit 14 stores, as the operation log, “occurrence time” of the operation, “unique information on an operated GUI component”, and the like. In addition, in the operation log, information on one operation event is expressed as a collection of a plurality of attribute values (columns, items).

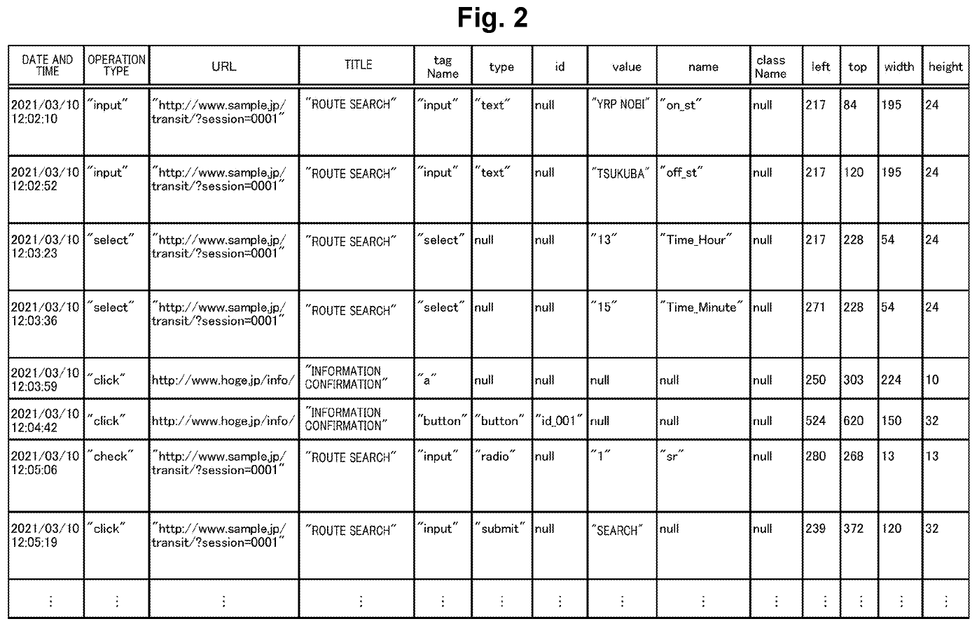

Here, the operation log stored in the storage unit 14 will be described with reference to FIG. 2. FIG. 2 is a diagram illustrating a log stored in the storage unit according to the first embodiment. In the example of FIG. 2, to simplify the example, an operation log is assumed in which only an operation on a browser is recorded. For that reason, attribute values of the log indicate only those related to the browser.

Note that, in the operation log, in addition to a GUI operation on the PC, input by some input device may be recorded, or command input on a character-based user interface (CUI) may be recorded. In a case of recording these other types of operations, it is necessary to increase the number of log items as necessary.

As illustrated in FIG. 2, the storage unit 14 stores “date and time”, “operation type”, “URL”, “title”, “tagName”, “type”, “id”, “value”, “name”, “className”, “left”, “top”, “width”, and “height”. Note that operation logs to be stored are not limited to those described above, and the storage unit 14 may also store, for example, image capture or the like at the time of operation.

In the example of FIG. 2, in a case where an item of an operation is not set or cannot be acquired, the storage unit 14 stores a “null” value indicating that a value of the operation is not set. Note that an attribute element included in the operation log does not need to be directly acquired information itself, and may be processed, obtained by combining a plurality of pieces of information, or processed by using information not included in the operation log finally. In addition, the storage unit 14 stores the operation logs in chronological order of events so that the order of the events occurring in work can be known.

The control unit 15 manages control of the entire determination device 10. The control unit 15 includes a reception unit 15a, an estimation unit 15b, and a determination unit 15c. Here, the control unit 15 is, for example, an electronic circuit such as a central processing unit (CPU) or a micro processing unit (MPU), or an integrated circuit such as an application specific integrated circuit (ASIC) or a field programmable gate array (FPGA).

### (Reception Unit 15a)

The reception unit 15a receives an operation event as a log event. For example, the reception unit 15a receives an image of an operation event selected by the user among images of a plurality of operation events. That is, the reception unit 15a receives a plurality of captured images selected as necessary or unnecessary by the user among the captured images of the plurality of operation events displayed in chronological order. Here, the log event is an event including a log having a similar structure (for example, a reception/transmission history of a telephone, and the like) in addition to the operation event.

Describing using a specific example, in a case where a plurality of captured images visually displayed chronologically on a screen of the user's terminal is selected as “necessary selection”, that is, an operation event to be left by a click operation by the user, the reception unit 15a receives an operation log of an operation event associated with the selected captured image as “necessary operation log”. On the other hand, in a case where a plurality of captured images visually displayed chronologically on the screen of the user's terminal is selected as “unnecessary selection”, that is, operation events to be removed by a click operation by the user, the reception unit 15a receives an operation log of an operation event associated with the selected captured image as “unnecessary operation log”. Note that reception processing described above will also be described in detail in [Details of each of pieces of processing] (1. Processing of receiving exemplification by selection of operation event) described later.

The reception unit 15a refers to the operation log stored in the storage unit 14 and acquires a selected operation log. On the other hand, the reception unit 15a outputs a set of selected operation logs to the estimation unit 15b. Note that the reception unit 15a may store the set of the selected operation logs in the storage unit 14.

### (Estimation Unit 15b)

The estimation unit 15b estimates, as the log event, a determination criterion (rule) for determining whether the operation event is necessary or unnecessary on the basis of the attribute value of the operation log included in the operation event. For example, the estimation unit 15b estimates a determination criterion for determining whether the operation event is necessary or unnecessary by extracting a common attribute value of the operation log. That is, the estimation unit 15b estimates the determination criterion for determining whether the operation event is necessary or unnecessary by extracting a character string or a numerical range commonly included in attribute elements in accordance with a condition (rule type) set for each attribute element (attribute element).

Describing using a specific example, in a case where a character string “route search” common to all is included as an attribute value of an attribute element “title” (rule type B: determine a character string by a partial match) in a plurality of operation logs received as the operation event of “necessary selection” by the reception unit 15a, the estimation unit 15b estimates an operation event including the character string “route search” in the attribute element “title”, as a determination criterion for the operation event to be left. Note that estimation processing described above will also be described in detail in [Details of each of pieces of processing] (4. Rule estimation processing for each attribute value) described later.

In addition, the estimation unit 15b acquires a set of operation logs output by the reception unit 15a and a rule type of the attribute value stored in the storage unit 14, and extracts a character string or a numerical range commonly included as a determination criterion. On the other hand, the estimation unit 15b outputs the extracted determination criterion to the determination unit 15c. Note that the estimation unit 15b may store the extracted determination criterion in the storage unit 14.

### (Determination Unit 15c)

The determination unit 15c determines whether the operation event to be processed is necessary or unnecessary as the log event to be processed on the basis of the determination criterion. For example, the determination unit 15c determines whether the operation event to be processed is necessary or unnecessary by using the extracted attribute value. That is, the determination unit 15c determines whether the operation event to be processed is necessary or unnecessary by matching an operation event including a character string commonly included in attribute elements or an operation event satisfying a numerical range commonly included in attribute elements.

Describing using a specific example, in a case where a fact that the character string “route search” is included in the attribute element “title” is estimated as a determination criterion for an operation event to be left, the determination unit 15c searches for an operation event in which the character string “route search” is included in the attribute element “title” from operation events that have not been selected by the user, and outputs the found operation event as a determination result. On the other hand, in a case where there is no determination criterion other than the above, the determination unit 15c outputs an operation event outside the operation events to be left as an operation event to be removed. Note that the determination processing described above will also be described in detail in [Details of each of pieces of processing] (5. Operation event determination processing) described later.

In addition, the determination unit 15c transmits the output determination result to the output unit 12. Note that the determination unit 15c may store the output determination result in the storage unit 14.

In addition, the determination unit 15c determines whether the operation event to be processed is necessary or unnecessary by presenting a determination result obtained by determining whether the operation event is necessary or unnecessary and outputting the determination result approved by the user.

Describing using a specific example, in a case where operation events including the character string “route search” in the attribute element “title” are output as operation events to be left in a plurality of visual images, the determination unit 15c outputs again an operation event in which a visual image is selected by a click operation by the user as a confirmed determination result. Note that the estimation processing described above will also be described in detail in [Details of each of pieces of processing] (6. Determination processing by interaction with user) described later.

### [Details of Each of Pieces of Processing]

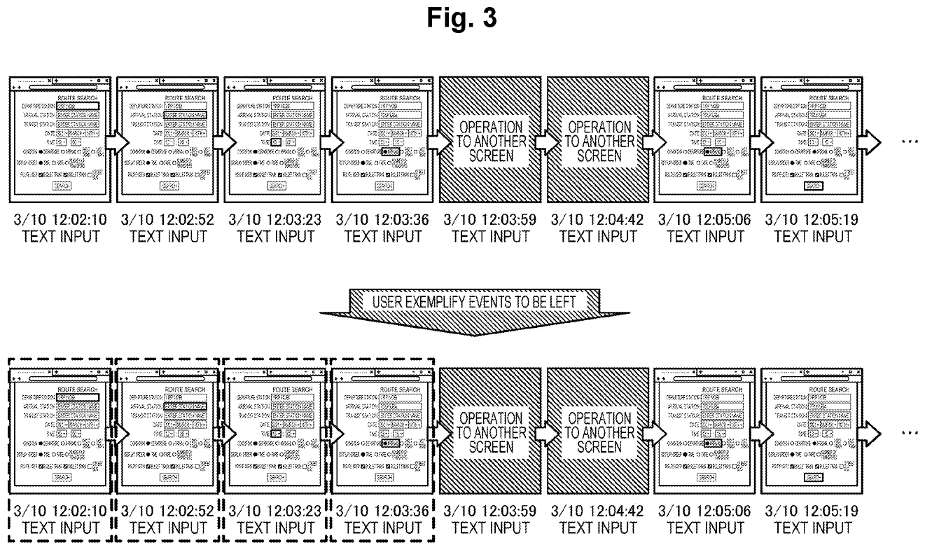

Details of each of pieces of processing according to the present embodiment will be described by using FIGS. 3 to 6, mathematical expressions, and the like. Hereinafter, detailed description will be given of processing of receiving exemplification by selection of an operation event, a rule type for each attribute value, rule details and rule estimation processing, and operation event determination processing.

### (1. Processing of Receiving Exemplification by Selection of Operation Event)

Processing of receiving exemplification by selection of an operation event will be described with reference to FIG. 3. FIG. 3 is a diagram illustrating an example of the processing of receiving exemplification by selection of an operation event according to the first embodiment.

First, the user is caused to select a plurality of operation events to be left or operation events to be removed as exemplification. For example, as illustrated in FIG. 3, the operation events may be visually displayed chronologically and caused to be selected by the user. In FIG. 3, one operation event is displayed as one node, a captured image recorded simultaneously with recording of the operation event is displayed on the node, and an operation position is displayed in a thick frame on the image. By performing display in this manner, the user can recognize which operation each operation event specifically is without understanding contents recorded in the operation log.

Then, the determination device 10 receives operation events (broken-line frames in the lower part of FIG. 3) selected by the user as the user's exemplification. Note that, FIG. 3 illustrates an example of operation events to be left, that is, necessary operation events, but it is also possible to select an operation event to be removed, that is, an unnecessary operation event.

### (2. Rule Type for Each Attribute Value)

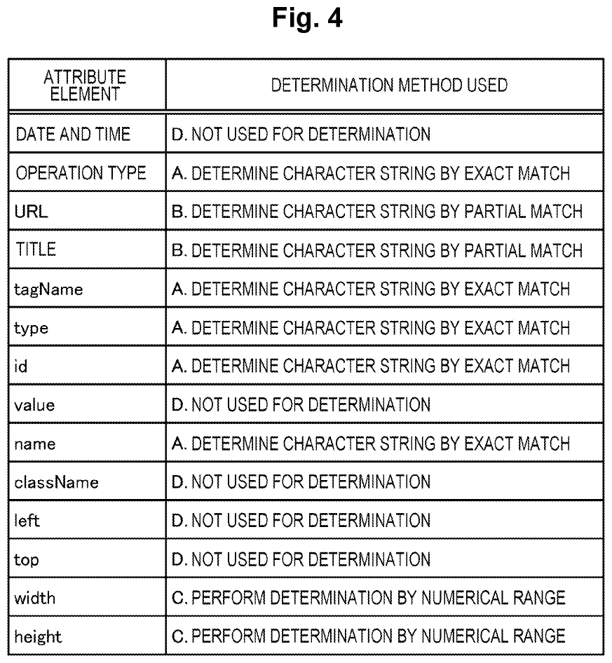

The rule type for each attribute value will be described with reference to FIG. 4. FIG. 4 is a diagram illustrating an example of the rule type for each attribute value according to the first embodiment.

The determination device 10 applies the following four types of rules also illustrated in FIG. 4 in accordance with a nature of each attribute value of the operation event. The first rule is “determine a character string by an exact match” (rule type A), the second rule is “determine a character string by a partial match” (rule type B), the third rule is “perform determination by a numerical range” (rule type C), and the fourth rule is “not used for determination” (rule type D).

As illustrated in FIG. 4, the user connects the attribute element with the rule type to be used in advance. For example, in FIG. 4, the rule type A is applied to attribute elements of “operation type”, “tagName”, “type”, “id”, and “name”, the rule type B is applied to attribute elements of “URL” and “title”, the rule type C is applied to attribute elements of “width” and “height”, and the rule type D is applied to attribute elements of “date and time”, “value”, “className”, “left”, and “top”. Note that the user may not use some of the above four types of rules or may add other types of rules.

### (3. Details of Rule for Each Attribute Value)

Prior to the rule estimation processing, details of the rule for each attribute value will be described. Hereinafter, description will be given of a character string determined by an exact match (rule details 1), a character string determined by a partial match (rule details 2), and an item determined by a numerical range (rule details 3) in this order.

### (Rule Details 1: Character String Determined by Exact Match)

First, details of a rule for determining a character string by an exact match (rule type A) will be described. Hereinafter, description will be given in the order of rule estimation processing to which the rule type A is applied and rule matching processing.

### (Rule Estimation Processing)

In a case where all the attribute values do not exactly match in the plurality of exemplified operation events, the determination device 10 rejects the present rule for the corresponding attribute element. On the other hand, in the plurality of exemplified operation events, the determination device 10 sets a character string that exactly matches in all the attribute values as a parameter of the present rule. In addition, in a case where it is not necessary to distinguish between upper case and lower case, parameters are converted into upper case or lower case and unified. Note that, also in a case where all the attribute values are “null” in the plurality of exemplified operation events, the present rule is adopted for the corresponding attribute element.

### (Rule Matching Processing)

In a case where the corresponding attribute value of the operation event to be inspected exactly matches the character string found in the present rule estimation processing described above, the determination device 10 determines that the present rule is a match (matched). In addition, in a case where it is not necessary to distinguish between upper case and lower case, the determination device 10 performs comparison using a value obtained by converting the corresponding attribute value into upper case or lower case, similarly to the parameters.

### (Rule Details 2: Character String Determined by Partial Match)

Second, details of a rule for determining a character string by a partial match (rule type B) will be described. Hereinafter, description will be given in the order of rule estimation processing to which the rule type B is applied and rule matching processing.

### (Rule Estimation Processing)

In a case where “null” is included in the corresponding attribute value in the plurality of exemplified operation events, the determination device 10 rejects the present rule for the corresponding attribute element. On the other hand, the determination device 10 finds a common partial character string in the plurality of exemplified operation events. At this time, in the simplest mechanism, the determination device 10 finds the longest common partial character string commonly included in all events, and uses the longest common partial character string as a parameter of the present rule.

In a case where the number of characters of the common partial character string is less than or equal to a threshold number of characters, the determination device 10 rejects the present rule. The threshold can be arbitrarily set, but for example, in a case of a URL, a portion of “http://” or “https://” at the head is always common, and thus, to exceed this, it is only required to reject the common partial character string of less than or equal to eight characters. Note that, to perform more advanced processing, information regarding true/false of “forward match”, “backward match”, “partial match”, and “exact match” may be considered, a plurality of common parts may be considered, or a character string length may be considered.

### (Rule Matching Processing)

In a Case where the Corresponding Attribute Value of the operation event to be inspected includes the common partial character string found in the present rule estimation processing described above, the determination device 10 determines that the present rule is a match (matched).

### (Rule Details 3: Item Determined by Numerical Range)

Third, details of a rule for determination by a numerical range (rule type C) will be described. Hereinafter, description will be given in the order of rule estimation processing to which the rule type C is applied and rule matching processing.

### (Rule Estimation Processing)

In the plurality of exemplified operation events, “in a case where null is included in the corresponding attribute value”, “in a case where a value that cannot be handled as a numerical value is included in the corresponding attribute value”, or “in a case where another abnormal value is included in the corresponding attribute value (example: width is a negative value)”, the determination device 10 rejects the present rule for the corresponding attribute element.

In addition, the determination device 10 calculates the average u and the standard deviation σ in the plurality of exemplified operation events, and uses the average u and the standard deviation σ as parameters of the present rule. At this time, the determination device 10 may reject the present rule in a case where the standard deviation σ is greater than or equal to a certain threshold or in a case where a sufficient number of operations are not exemplified (only one operation is exemplified). For example, in a case where the threshold is set to 30, and in a case where the standard deviation σ is greater than or equal to 30, it is regarded that the variation is large and there is almost no commonality, and the rule is rejected.

### (Rule Matching Processing)

In a case where the corresponding attribute value of the operation event to be inspected falls within a range of μ−kσ≤attribute value≤μ+kσ, the determination device 10 determines that the present rule is a match (matched). Here, k is a constant and is arbitrarily determined. In addition, in a case where it is assumed that variation of values follows a normal distribution, k=3 (range of 99.7%) is generally preferable.

### (4. Rule Estimation Processing for Each Attribute Value)

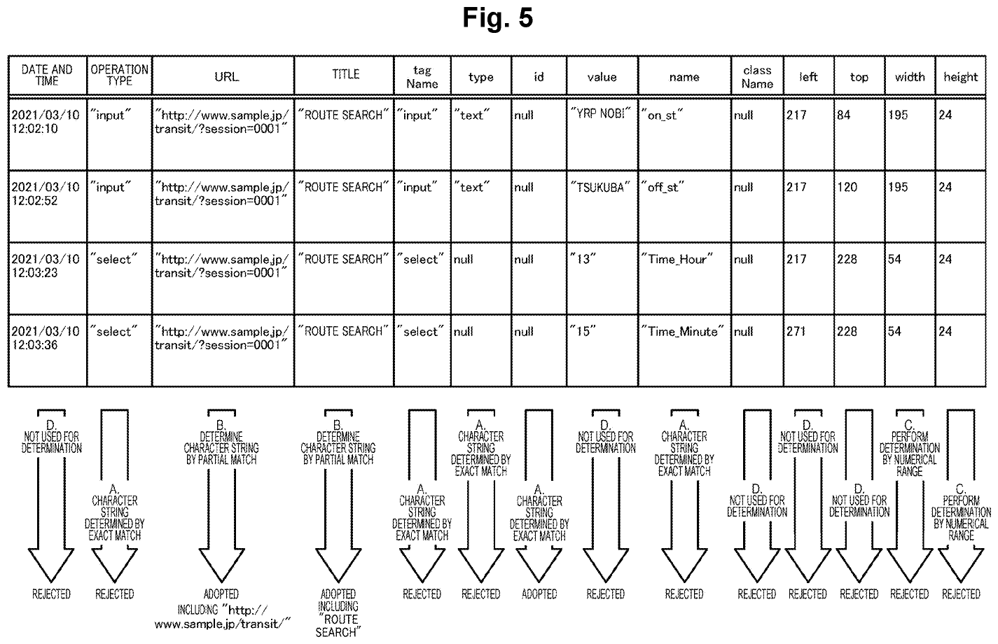

Details of processing of estimating the rule for each attribute value will be described with reference to FIG. 5. FIG. 5 is a diagram illustrating an example of determination criterion estimation processing according to the first embodiment. The determination device 10 estimates a rule for each attribute element for the operation log data of the plurality of exemplified operation events as follows. FIG. 5 illustrates operation logs of four operation events exemplified.

First, the determination device 10 determines “adopted” or “rejected” for each attribute element in accordance with a rule type set in advance for each attribute element. Next, the determination device 10 extracts a parameter from an attribute value of an attribute element determined as “adopted”. Then, the determination device 10 estimates the extracted parameter as a rule corresponding to the attribute element.

In the example of FIG. 5, since a common character string “http://www.sample.jp/transit/” is included as an attribute value of the attribute element “URL” (rule type B: determine a character string by a partial match), the determination device 10 determines the attribute element as “adopted” and extracts, as a parameter, that “http://www.sample.jp/transit/” is included as a character string. In addition, since a common character string “route search” is included as an attribute value of the attribute element “title” (rule type B: determine a character string by a partial match), the determination device 10 determines the attribute element as “adopted” and extracts that “route search” is included as a character string as a parameter.

### (5. Operation Event Determination Processing)

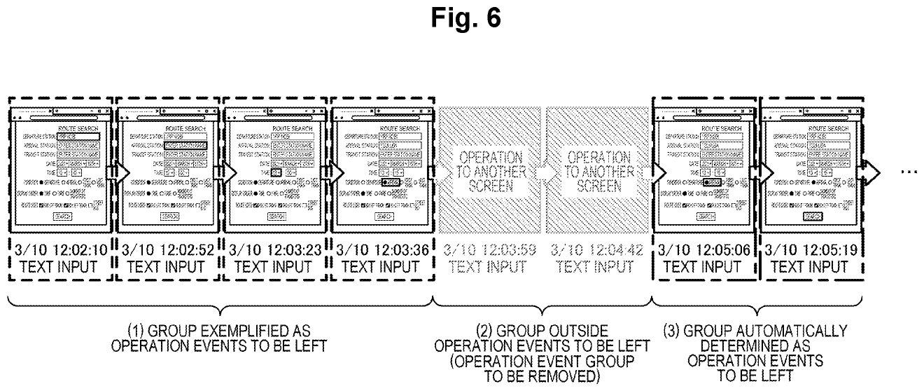

Details of processing of determining an operation event from the estimated rule will be described with reference to FIG. 6. FIG. 6 is a diagram illustrating an example of operation event determination processing according to the first embodiment. The determination device 10 uses the estimated rule to check the rule for an operation event other than the exemplified operation event and determine an operation event to be left/removed. In FIG. 6, operation events that do not correspond to the estimated rule are removed.

In the example of FIG. 6, the determination device 10 uses a rule (example: the character string “http://www.sample.jp/transit/” is included in the attribute element “URL”; the character string “route search” is included in the attribute element “title”) estimated from “a group exemplified as operation events to be left” (see (1) of FIG. 6) to determine “a group outside operation events to be left (operation event group to be removed)” (see (2) of FIG. 6) and “a group automatically determined as operation events to be left” (see (3) of FIG. 6).

(6. Determination Processing by Interaction with User)

Hereinafter, details of processing of determining an operation event by interaction with the user will be described. The determination device 10 cannot correctly determine the operation event to be left/removed in some cases, such as a case where the number of operation events exemplified above is small or a case where variety of the exemplified operation events is insufficient. For that reason, instead of immediately confirming the determination result, the determination device 10 can temporarily indicate a determined operation event to the user, and confirm the determination result of the operation event to be left/removed after confirmation from the user. That is, in a case where the presented determination result is determined to be inappropriate by the user, the determination device 10 can also prompt the user to cancel the temporary determination result once and increase the number of exemplifications.

By gradually increasing the number of exemplifications by such interactive exchange, it is possible to cause the user to more efficiently exemplify operation events. Further, by providing a user interface (UI) that allows ON/OFF of various set thresholds and rules adopted by estimation, it is also possible to respond more advanced user requirements.

### [Flow of Each of Pieces of Processing]

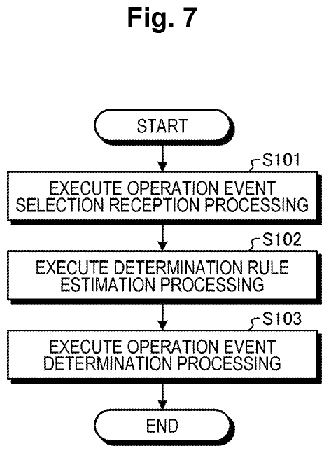

A flow of each of pieces of processing according to the present embodiment will be described in detail with reference to FIG. 7. FIG. 7 is a flowchart illustrating an example of a flow of entire processing according to the first embodiment. Hereinafter, a flow of the entire determination processing will be described, and an outline of each of pieces of processing will be described.

### (Flow of Entire Processing)

First, the reception unit 15a of the determination device 10 executes operation event selection reception processing (step S101). Next, the estimation unit 15b of the determination device 10 executes determination rule estimation processing (step S102). Then, the determination unit 15c of the determination device 10 executes operation event determination processing (step S103), and ends the processing. Note that the following steps S101 to S103 can be executed in different orders. In addition, there may be omitted processing among the following steps S101 to S103.

### (Flow of Each of Pieces of Processing)

First, the operation-event selection reception processing by the reception unit 15a will be described. In this processing, the user is caused to select a plurality of operation events to be left or operation events to be removed as exemplification, and an operation log of the selected operation event is received. At this time, by visually displaying the operation events chronologically and causing the user to select the operation events, the user can recognize which operation each operation event specifically is without understanding contents recorded in the operation log.

Second, the determination rule estimation processing by the estimation unit 15b will be described. In this processing, in accordance with a rule type set in advance for each attribute element of the operation event for which selection is received, “adopted” or “rejected” is determined for each attribute element, a parameter is extracted from an attribute value of the attribute element determined as “adopted”, and the extracted parameter is estimated as a rule corresponding to the attribute element. At this time, by connecting the attribute element with the rule type to be used in advance, it is possible to effectively estimate a determination rule of the selected operation event.

Third, the determination rule estimation processing by the determination unit 15c will be described. In this processing, the estimated determination rule is used to check the rule for an operation event other than the exemplified operation event, and the operation event to be left/removed is determined. At this time, by temporarily indicating the determined operation event to the user instead of immediately confirming the determination result, and confirming the determination result of the operation event to be left/removed after confirmation from the user, it is possible to prompt the user to gradually increase the number of exemplifications by interactive exchange, and it is possible to easily and effectively determine the operation event to be left/removed.

### Effects of First Embodiment

First, in the determination processing according to the present embodiment described above, an operation event is received, a determination criterion for determining whether the operation event is necessary or unnecessary is estimated on the basis of an attribute value of an operation log included in the operation event, and whether an operation event to be processed is necessary or unnecessary is determined on the basis of the estimated determination criterion. For this reason, in the present processing, in the pre-processing for the process mining, the unnecessary operation event can be easily removed.

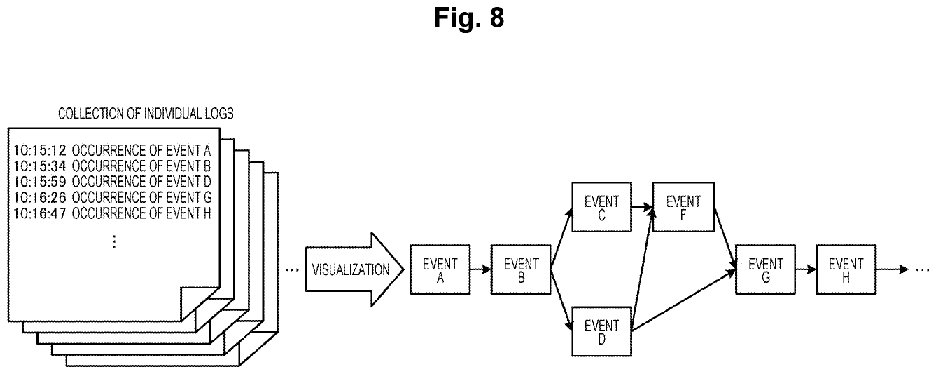

Here, the process mining will be described. In the process mining, as illustrated in FIG. 8, it is possible to analyze a flow of work performed in business by visualizing the order and relationship of events. FIG. 8 is a diagram for explaining the process mining.

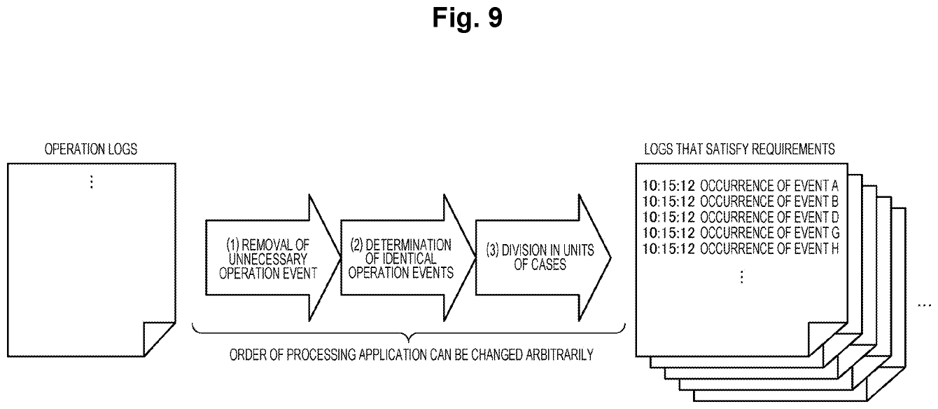

In such process mining, as illustrated in FIG. 9, when the process mining is performed, for example, “removal of an unnecessary operation event”, “determination of identical operation events”, and “division in units of cases” are required as the pre-processing. FIG. 9 is a diagram for explaining the pre-processing for the process mining.

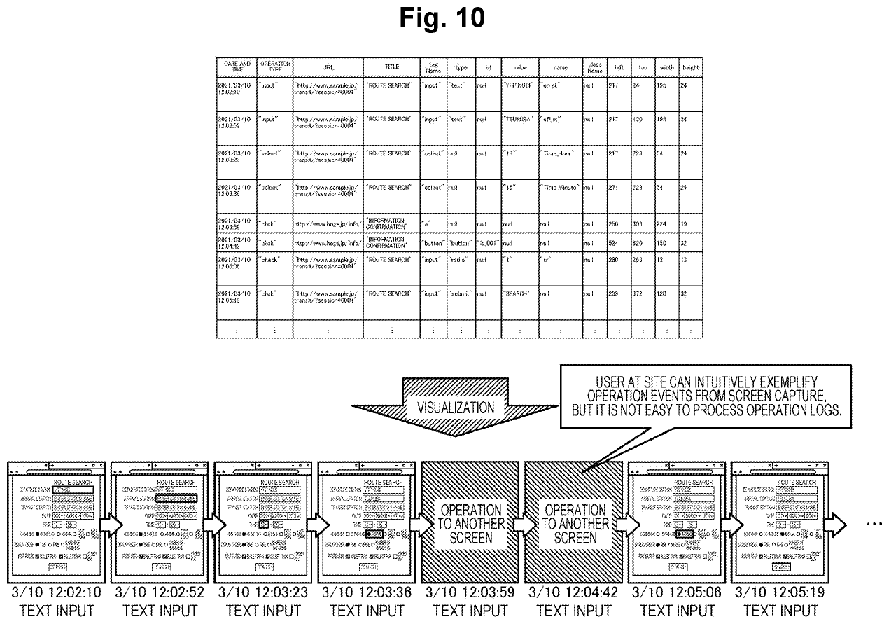

Conventionally, such pre-processing is performed manually. For example, when such pre-processing is manually performed, as illustrated in FIG. 10, the user at a site can intuitively exemplify operation events from screen capture, but it may not be easy to process operation logs. FIG. 10 is a diagram for explaining a conventional problem. For example, the attribute value recorded in the operation log requires specialized knowledge for interpretation. For example, to interpret the meaning of the operation log in which the operation on the browser is recorded, knowledge of hyper text markup language (HTML) or DOM is required. In addition, URLs and the like may not be completely the same even in the same page. In addition, for example, in a case where a session ID is included, since a part of the URL changes every time login is performed, it is necessary to estimate a URL generation rule to determine the identity of the URL.

As described above, since there is no relationship between appearance in the screen and an internal structure (such as a method of assigning an ID), the internal structure cannot be estimated from similarity in appearance that can be determined by a general user. Since there are various internal structures in the screen, the best determination cannot always be made by a fixed algorithm. A user having specialized knowledge can cope with various screen structures by estimating a rule from a tendency of the operation log and constructing an algorithm, but it is difficult for a general user.

For this reason, in a case where division of the operation log in units of cases is manually performed, it is necessary for a worker to understand an internal structure of a system and a meaning of an attribute value of the operation log, and further, it requires a large operation to handle a large amount of logs, and in addition, in a fixed rule algorithm, systems have different internal structures, so that there has been a problem that it is difficult to automatically divide the operation log in units of cases. On the other hand, in the determination processing according to the present embodiment, the unnecessary operation event can be easily removed in the pre-processing for the process mining. In addition, effects that can be achieved by the determination processing according to the present embodiment will be further described below.

In the determination processing according to the present embodiment described above, the image of the operation event selected by the user is received among the images of the plurality of operation events, the determination criterion for determining whether the operation event is necessary or unnecessary is estimated by extracting the common attribute value of the operation log, and whether the operation event to be processed is necessary or unnecessary is determined by using the extracted attribute value. For this reason, in the present processing, in the pre-processing for the process mining, the unnecessary operation event can be easily removed by using the criterion of the common attribute value of the operation log on the basis of the selection operation of the image.

In the determination processing according to the present embodiment described above, among captured images of a plurality of operation events displayed in chronological order, a plurality of the captured images selected as necessary or unnecessary by the user is received, the determination criterion is estimated by extracting a character string or a numerical range commonly included in attribute elements in accordance with a condition set for each of the attribute elements, and whether the operation event to be processed is necessary or unnecessary is determined by matching an operation event including the character string or operation events satisfying the numerical range. For this reason, in the present processing, in the pre-processing for the process mining, it is possible to easily remove the unnecessary operation event by using the common attribute value of the operation log on the basis of the operation of the image in accordance with the condition set for each of the attribute elements.

In the determination processing according to the present embodiment described above, whether the operation event to be processed is necessary or unnecessary is determined by presenting a determination result obtained by determining whether the operation event is necessary or unnecessary and outputting the determination result approved by the user. For this reason, in the present processing, in the pre-processing for the process mining, the unnecessary operation event can be easily and more effectively removed.

### [System Configuration or the Like]

Each component of each device that has been illustrated according to the embodiment described above is functionally conceptual and does not necessarily have to be physically configured as illustrated. In other words, a specific form of distribution and integration of individual devices is not limited to the illustrated form, and all or part of the configuration can be functionally or physically distributed and integrated in any unit according to various loads, usage conditions, and the like. Further, all or any part of each processing function performed in each device can be implemented by a CPU and a program to be analyzed and executed by the CPU or can be implemented as hardware by wired logic.

Further, among the individual processing described in the embodiment described above, all or part of the processing described as being automatically performed can be manually performed, or all or part of the processing described as being manually performed can be automatically performed by a known method. In addition, the processing procedure, the control procedure, the specific name, and the information including various data and parameters that are illustrated in the document and the drawings can be freely changed unless otherwise specified.

### [Program]

In addition, it is also possible to create a program in which the processing executed by the determination device 10 described in the above embodiment is described in a language that can be executed by a computer. In this case, the computer executes the program, and thus the advantageous effects similar to those of the above-described embodiment can be obtained. Furthermore, the program may be recorded in a computer-readable recording medium, and the program recorded in the recording medium may be read and executed by the computer to implement processing similar to the embodiment described above.

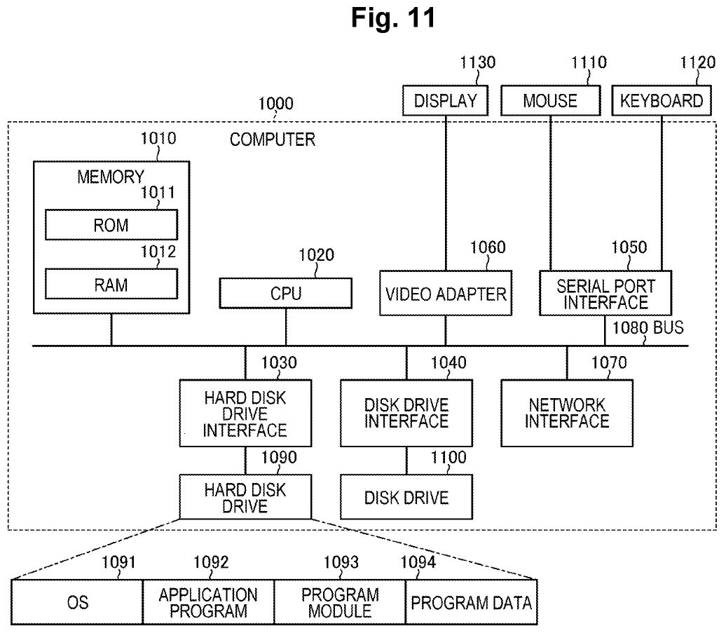

FIG. 11 is a diagram illustrating a computer that executes the program. As illustrated in FIG. 11, a computer 1000 includes a memory 1010, a CPU 1020, a hard disk drive interface 1030, a disk drive interface 1040, a serial port interface 1050, a video adapter 1060, and a network interface 1070, for example, and these units are connected to each other by a bus 1080.

As illustrated in FIG. 11, the memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090 as illustrated in FIG. 11. The disk drive interface 1040 is connected to a disk drive 1100 as illustrated in FIG. 11. For example, a removable storage medium such as a magnetic disk or an optical disk is inserted into the disk drive 1100. As illustrated in FIG. 11, the serial port interface 1050 is connected to, for example, a mouse 1110 and a keyboard 1120. As illustrated in FIG. 11, the video adapter 1060 is connected to, for example, a display 1130.

Here, as illustrated in FIG. 11, the hard disk drive 1090 stores, for example, an OS 1091, an application program 1092, a program module 1093, and program data 1094. In other words, the above program is stored, for example, in the hard disk drive 1090 as a program module in which a command to be executed by the computer 1000 is described.

Further, various data described in the embodiment described above is stored as program data in, for example, the memory 1010 and the hard disk drive 1090. Then, the CPU 1020 reads out the program module 1093 and the program data 1094 stored in the memory 1010 and the hard disk drive 1090 to the RAM 1012 as necessary and executes various processing procedures.

Note that the program module 1093 and the program data 1094 related to the program are not limited to being stored in the hard disk drive 1090 and may be stored in, for example, a removable storage medium and may be read by the CPU 1020 via a disk drive, or the like. Alternatively, the program module 1093 and the program data 1094 related to the program may be stored in another computer connected via a network (such as a local area network (LAN) or a wide area network (WAN)) and may be read by the CPU 1020 via the network interface 1070.

The embodiment described above and modifications thereof are included in the inventions recited in the claims and the equivalent scope thereof, similarly to being included in the technique disclosed in the present application.

### REFERENCE SIGNS LIST

10 determination device
11 input unit
12 output unit
13 communication unit
14 storage unit
15 Control unit
15a reception unit
15b estimation unit
15c determination unit

1. A determination device comprising a processor configured to execute operations comprising:
receiving a log event;
estimating a determination criterion for determining whether the log event is necessary or unnecessary on a basis of an attribute value of a log included in the log event; and
determining whether a log event to be processed is necessary or unnecessary on a basis of the determination criterion.

2. The determination device according to claim 1, wherein
the receiving further comprises receiving, as the log event, an image of an operation event selected by a user among images of a plurality of operation events,
the estimating further comprises estimating the determination criterion by extracting the attribute value common of an operation log as the log, and
the determining further comprises determining whether the operation event to be processed is necessary or unnecessary by using the attribute value extracted.

3. The determination device according to claim 2, wherein
the receiving further comprises receiving, among captured images of a plurality of operation events displayed in chronological order, a plurality of the captured images selected as necessary or unnecessary by the user,
the estimating further comprises estimating the determination criterion by extracting a character string or a numerical range commonly included in attribute elements in accordance with a condition set for each of the attribute elements, and
the determining further comprises determining whether the operation event to be processed is necessary or unnecessary by matching an operation event including the character string or an operation event satisfying the numerical range.

4. The determination device according to claim 3, wherein
the determining further comprises determining whether the operation event to be processed is necessary or unnecessary by presenting a determination result obtained by determining whether the operation event is necessary or unnecessary to the user and outputting the determination result approved by the user.

5. A determination method, comprising:
receiving a log event;
estimating a determination criterion for determining whether the log event is necessary or unnecessary on a basis of an attribute value of a log included in the log event; and
determining whether a log event to be processed is necessary or unnecessary on a basis of the determination criterion.

6. A computer-readable non-transitory recording medium storing a computer-executable program instructions that when executed by a processor cause a computer system to execute operations comprising:
receiving a log event;
estimating a determination criterion for determining whether the log event is necessary or unnecessary on a basis of an attribute value of a log included in the log event; and
determining whether a log event to be processed is necessary or unnecessary on a basis of the determination criterion.

7. The determination device according to claim 1, wherein the log event includes an operation event of operating a computer by using a graphical user interface.

8. The determination device according to claim 1, wherein the receiving the log event further comprises interactively receiving a selection of the log event and the attribute value indicating necessary and not for removal.

9. The determination device according to claim 1, wherein the receiving the log event further comprises interactively receiving a selection of the log event and the attribute value indicating unnecessary and the log event is subject to removal, and the determination method further comprising:
transmitting the determined log event to an application configured to remove the determined log event.

10. The determination method according to claim 5, wherein
the receiving further comprises receiving, as the log event, an image of an operation event selected by a user among images of a plurality of operation events,
the estimating further comprises estimating the determination criterion by extracting the attribute value common of an operation log as the log, and
the determining further comprises determining whether the operation event to be processed is necessary or unnecessary by using the attribute value extracted.

11. The determination method according to claim 10, wherein
the receiving further comprises receiving, among captured images of a plurality of operation events displayed in chronological order, a plurality of the captured images selected as necessary or unnecessary by the user,
the estimating further comprises estimating the determination criterion by extracting a character string or a numerical range commonly included in attribute elements in accordance with a condition set for each of the attribute elements, and
the determining further comprises determining whether the operation event to be processed is necessary or unnecessary by matching an operation event including the character string or an operation event satisfying the numerical range.

12. The determination method according to claim 11, wherein
the determining further comprises determining whether the operation event to be processed is necessary or unnecessary by presenting a determination result obtained by determining whether the operation event is necessary or unnecessary to the user and outputting the determination result approved by the user.

13. The determination method according to claim 5, wherein the log event includes an operation event of operating a computer by using a graphical user interface.

14. The determination method according to claim 5, wherein the receiving the log event further comprises interactively receiving a selection of the log event and the attribute value indicating necessary and not for removal.

15. The determination method according to claim 5, wherein the receiving the log event further comprises interactively receiving a selection of the log event and the attribute value indicating unnecessary and the log event is subject to removal, and the determination method further comprising:
transmitting the determined log event to an application configured to remove the determined log event.

16. The computer-readable non-transitory recording medium according to claim 6, wherein
the receiving further comprises receiving, as the log event, an image of an operation event selected by a user among images of a plurality of operation events,
the estimating further comprises estimating the determination criterion by extracting the attribute value common of an operation log as the log, and
the determining further comprises determining whether the operation event to be processed is necessary or unnecessary by using the attribute value extracted.

17. The computer-readable non-transitory recording medium according to claim 16, wherein
the receiving further comprises receiving, among captured images of a plurality of operation events displayed in chronological order, a plurality of the captured images selected as necessary or unnecessary by the user,
the estimating further comprises estimating the determination criterion by extracting a character string or a numerical range commonly included in attribute elements in accordance with a condition set for each of the attribute elements, and
the determining further comprises determining whether the operation event to be processed is necessary or unnecessary by matching an operation event including the character string or an operation event satisfying the numerical range.

18. The computer-readable non-transitory recording medium according to claim 17, wherein
the determining further comprises determining whether the operation event to be processed is necessary or unnecessary by presenting a determination result obtained by determining whether the operation event is necessary or unnecessary to the user and outputting the determination result approved by the user.

19. The computer-readable non-transitory recording medium according to claim 6, wherein the log event includes an operation event of operating a computer by using a graphical user interface.

20. The computer-readable non-transitory recording medium according to claim 6, wherein the receiving the log event further comprises interactively receiving a selection of the log event and the attribute value indicating unnecessary and the log event is subject to removal, and
the computer-executable program instructions when executed further causing the computer system to execute operations comprising:
transmitting the determined log event to an application configured to remove the determined log event.
